(19) United States
(12) Patent Application Publication
(10) Pub. No.: US 2016/0005332 A1
(43) Pub. Date: Jan. 7, 2016

(54) METHOD FOR ADMINISTERING A DRIVING TEST

(71) Applicant: Michael CALE, Kiriat Tivon (IL)

(72) Inventor: Michael CALE, Kiriat Tivon (IL)

(73) Assignee: Michal CALE, Kiriat Tivon (IL)

(21) Appl. No.: 14/767,932

(22) PCT Filed: Dec. 25, 2013
(86) PCT No.: PCT/IL13/51066

§ 371 Date: Aug. 14, 2015

Related U.S. Application Data
(60) Provisional application No. 61/765,742, filed on Feb. 17, 2013.

(51) Int. Cl. G09B 19/14; G09B 5/00; G09B 19/16

(52) U.S. Cl. CPC G09B 19/14; G09B 19/167; G09B 5/00

(57) ABSTRACT

A method for administering a driving test providing a mobile computing device in wireless communication with a test server initially receives from the test server a driving test, which includes a test route and test events along the test route. As the test vehicle is driven along the test route, whenever the current location of the test vehicle match the location coordinates of a test event, the mobile device outputs a description of the test event and captures input from the driving tester indicative of the test subject's performance on the test event. External black box data or video images may also be input to the mobile device. At the end of the test the captured input is uploaded to the test server for scoring.

### CROSS-REFERENCE TO RELATED APPLICATION

This application claims the benefit of U.S. Provisional Application No. 61/765,742, filed February 17, 2013.

### FIELD OF THE INVENTION

The present invention generally relates to a method for administering a driving test, more particularly, to a method for administering a driving test by capturing and recording events along a driving test route and processing the results.

### BACKGROUND OF THE INVENTION

The present invention relates to a method for administering a driving test and, more particularly, to a method for administering a driving test by capturing and recording events along a driving test route and processing the results.

Authorities in the modern world typically issue a driving license after an applicant has passed two tests:
A theoretical test, which is a written or a computerized test, which examines knowledge and understanding of traffic laws, traffic signs and familiarity with the basic components of motor vehicles.
A practical test which examines the ability of the applicant to operate and control a vehicle on a roadway, which test basic skills such as driving safely and obeying traffic signs and rules, as well as specific driving skills such as merging into traffic and parking.

The standards of the practical driving test differ between counties, states and countries. Typically, the driving tester will require the applicant to drive in town and/or on interurban roads and park the vehicle following the tester's directions. The aim of the practical driving test is to examine carefully the driving skills and behavior of the applicant in order to prevent unskilled or unsafe drivers from obtaining a driver's license. The practical driving test as known today has a large number of drawbacks.

Conventional methods used today to pass or fail an applicant taking the practical driving test is centered on and around the particular driving tester's subjective impressions of the test taker's driving ability. There is currently no way of supervising a driving test or reviewing an actual driving test in order to reliably and objectively challenge the decision of the driving tester. As a result, driving testers who are not skilled enough or are in a bad mood can often fail an applicant without merit—prohibiting the applicant from receiving a driving license until the applicant passes a subsequent driving test, unnecessarily resulting in wasted money and time along with the feeling of failure. Conversely, under the current method a poor driver can “get lucky” and undeservedly pass a driving test due only to the poor judgment of the tester. Also under the current method, due to the subjective nature of the examination, applicants and driving teachers usually receive very little, if any, information or feedback as to errors made which caused the applicant to fail. This in turn inhibits subsequent improvement.

Thus there is currently an unmet need for a driving license authority to obtain credible and objective data about a particular applicant's performance during a driving test in order to ensure a minimal level of driving skill.

In addition, there is also an unmet need for a driving license authority to design and administer a driving test which objectively tests those driving skills which are deemed necessary to prevent most types of traffic accidents in which new drivers are involved in. For example, by gathering statistics about the most common accidents involving new drivers, a driving license authority can design a driving test which evaluates every applicant's skill in certain key areas, and update the focus areas tested in response to updated statistics.

Additionally there is also an unmet need for driving students desirous of evaluating potential driving instructors to have current data as to the performance of driving instructors as measured by the number of past students who passed or failed a driving test. Additionally, there is an unmet need for a system where accident reports can be compared to recorded driving test data in order to determine which if any types of mistakes made on driving tests may be predictive of likely future accidents by the test subject. Furthermore objectively recorded data about errors made on a driving test can help an agency identify and eliminate dangerous traffic situations.

### SUMMARY OF THE INVENTION

It is one object of the present invention to provide a method for administering a driving test including the steps of: (a) providing a mobile computing device and a test vehicle; (b) receiving from a server a driving test, said driving test including at least one test route and at least one test event, said test event including a set of location coordinates corresponding to location of said test event; (c) continuously receiving sets of location coordinates corresponding to the current location of said test vehicle in which said mobile computing device is traveling; and wherein said method further comprising the steps of (d) generating a description of said test event when said location coordinates of said test vehicle matches said set of location coordinates of said test event and (e) capturing user input indicative of said test subject's performance in respect of said test event.

Preferably the server creates the test based on predefined driving test constructs, or the server selects the driving test from a plurality of predefined tests based on predefined test constructs, or the server randomly selects the driving test from a plurality of predefined tests.

Preferably the method further comprising the steps of: (f) authenticating a test subject's credentials, preferably biometric credentials, with the server prior to receiving the driving test; (g) receiving one or more video camera feeds from one or more video cameras fixed to the test vehicle, capturing video camera images from the one or more feeds, and recording the test vehicle's position at the time of each the capture, and (h) receiving one or more vehicular event data from one or more black box event data recorders fixed to the test vehicle, capturing vehicular data from the one or more feeds, and recording the test vehicle's position at the time of each the capture.

It is another object of the present invention to provide a non-transitory computer-readable storage medium having computer readable code embodied thereon, the computer readable code including a set of instructions that when executed on a mobile device causes the mobile device to: (a) receive from a server a driving test route, at least one test event associated with a location along the route, and for each such test event, a set of location coordinates corresponding to the test event; (b) receive from a geolocating device a set of location coordinates corresponding to the current location for the mobile computing device; and wherein said mobile computing device is instructed to (d) generate a description of said test event when said set of location coordinates received from said geolocating device matches said set of location coordinates corresponding to said test event received from said server and to (e) capture user input representing a test subject's performance in respect of said test event.

Preferably the code includes instructions that cause the mobile computing device to: (f) authenticate a test subject's credentials with the server prior to receiving the route and the at least one test event. Preferably the credentials are biometric credentials.

Preferably the code includes instructions that cause the mobile computing device to: (g) receive one or more video camera feeds from one or more video cameras fixed to the test vehicle; (h) capture video camera images from the one or more feeds; (i) record the test vehicle's position at the time of each the capture, (g) receive one or more vehicular event data from one or more black box event data recorders fixed to the test vehicle, (k) capture vehicular data from the one or more data recorders, and (1) record the test vehicle's position at the time of each the capture.

It is a further object of the present invention to provide a system for administering a driving test including a server, a client device in operative communication with the server, and a geolocating device operatively connected to the client device, the client device is operative to receive from the server a driving route, one or more test events, at least one test event corresponding to a respective fixed location along the driving route, and fixed location coordinates corresponding to the fixed location for each the at least one test event; wherein the client device is operative to receive from the geolocating device current location coordinates corresponding to the client device's current location; wherein said client device generates a description of said test event when said client device's current location matches a fixed location for said test event and captures user input indicative of a test subject's performance on said test event.

It is another object of the present invention to provide a non-transitory computer-readable storage medium having computer readable code embodied thereon, the computer readable code including a set of instructions that when executed on a host computer causes the host computer to administer a driving test by: (a) determining, based on a set of pre-defined criteria, a driving test route and at least one test event along the route, each of the at least one test event being associated with a set of location coordinates; (b) sending to a mobile device the driving test route and the one or more test events; and (c) receiving from the mobile device a respective performance grade for at least one the test event.

Preferably the instructions further include: (d) calculating a score for the driving test based in part on each the received performance grade.

It is another object of the present invention to provide a server including: a processor, and a non-volatile memory, operationally coupled to the processor on which is stored executable code readable by the processor, the code including instructions that when executed on a host computer causes the host computer to administer a driving test by: (a) determining, based on a set of pre-defined criteria, a driving test route and at least one test event along the route, each of the at least one test event being associated with a set of location coordinates; (b) sending to a mobile device the driving test route and the one or more test events; and (c) receiving from the mobile device a respective performance grade for at least one the test event.

Preferably the instructions further include: (d) calculating a score for the driving test based in part on each the received performance grade.

### BRIEF DESCRIPTION OF THE FIGURES

For a better understanding of the invention and to show how the same may be carried into effect, various embodiments are herein described, by way of example only, with reference to the accompanying drawings, wherein:

FIG. 1 is a flow diagram of an exemplary embodiment of a method of administering a driving test according to the present invention;

FIG. 2 is a high level partial block diagram of an exemplary hardware embodiment of a system according to the present invention;

FIG. 3 is a high level partial block diagram of an exemplary software embodiment of the present invention;

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The principles and operation of a method for administering a driving test according to the present invention may be better understood with reference to the drawings and the accompanying description.

Described herein is an innovative method of administering a driving test by having a driving tester interact with a mobile computing device, such as a smart phone, a tablet or a laptop, during the driving test and grade the student on a series of pre-determined test events based on relevant test constructs which are displayed on the mobile computing device while the student drives the test vehicle. The mobile computing device includes or is connected to a geolocating device, preferably a GPS receiver, which tracks the test vehicle's position as the test vehicle travels along the test route. The vehicle's position is continuously (i.e. every few seconds, or every few meters) fed back to the mobile computing device, whereupon at various pre-programmed positions along the test route, the mobile computing device outputs a description of the next test event and receives as input the student's grade for that test event.

In one embodiment, a driving test, which includes a driving route and one or more fixed test events along the driving route, is created on the fly by software running on the test server. In another embodiment the test is selected by software running on the test server from a list of pre-determined tests.

In one embodiment the test is created or selected according to test constructs required by the licensing agency thus creating a test according to predefined and scientifically validated criteria. Examples of predefined criteria include level of difficulty, particular driving maneuvers such as turning left, approaching a level crossing, approaching a zebra crossing, accelerating on a hill, parking, changing lanes or keeping correct distance from cars ahead. In one embodiment, the test route and test events are determined for an applicant based on one or more other criteria, such as current traffic information, previous tests, current hazardous situations, etc. In another embodiment the test route is selected randomly.

The driving test server sends the route and fixed test events to the mobile device used by the driving tester, either before the applicant begins driving or while the applicant is driving. In one embodiment the mobile device downloads the test route and fixed test events from the test server before the test begins. In another embodiment the mobile device downloads the test route and fixed test events while the student drives based on current traffic flow and performance of the applicant. In one embodiment, the student is first authenticated by the driving test server, for example by uploading to the driving test server the student's password or biometric identification data (e.g. fingerprint, retinal scan, facial recognition, etc.) before a driving test route can be downloaded.

Once the driving test route is downloaded and displayed for the driving tester, the tester instructs the student to begin driving. The driving test route is not known in advance by either the tester or the student. Preferably, the particular test events associated with a given route is also not known in advance by either tester or student. As the student drives along the test route, upon reaching designated pre-programmed positions along the test route a description of a test event associated with the driving test route pops up on the mobile computing device. Examples of test events include left turns, lane changes, approaches to traffic light controlled intersections, etc.

Upon displaying a description of the test event, the mobile computing device displays an input screen where the driving instructor is prompted to enter a simple one or two key response which is indicative of the student's performance on the test event. For example the driving tester may be asked to enter ‘1’ for pass and ‘2’ for fail. Alternatively, the tester may be asked to input a number from 1 to 5 where 1 is poor and 5 is excellent. In one embodiment the tester may also input additional observations in text and/or audio format such as by entering text or recording a voice memo on the mobile device. In one embodiment a recorded voice memo may be converted to text using commonly available speech to text software.

Test events are either fixed test events or spontaneous test events. Fixed test events are determined and supplied by the test server while spontaneous test events are optionally added on the fly by the driving tester during the test. Fixed test events may fall into one of two categories: Route dependent test events and route independent test event. Route dependent test events are, as the name implies, test events which are only applicable to the particular test. A route dependent test event may test the student's skill at controlling the vehicle through a particular left turn, railway crossing, stop sign, or roundabout. Route independent test events are not tied to any particular route, but rather, test general driving skill such as lane changes, parking, mirror checking, etc.

At the end of the driving test, a cumulative score is calculated for the student based on the grades received for each test event. Depending on the student's score, the student passes or fails the driving test. In a preferred embodiment, the mobile computing uploads the raw data to the test server, and the test server is responsible for calculating the result. In one embodiment the tester may recommend a pass or fail. In one embodiment, the tester's reputation or level of experience is taken into account by the computer system in calculating the final score by placing more or less weight on the tester's observations or recommendation vs. relying on physical data i.e. black box data, geolocator data, and video feeds. In one embodiment, the scoring methodology is tied to the test constructs which were used to create the test, i.e. more or less weight is given to specific test events as dictated by the test constructs. In another embodiment, the mobile computing device may calculate the score and display a performance report. In any event, preferably, all data generated or collected at the client device, including external data, is at some point uploaded to the test server where it is saved in non-volatile memory for later examination, for example:
1. To provide the student and/or the student's driving instructor with a detailed report describing his/her performance in each test event as graded by the tester;
2. To support any later challenges to the final result;
3. To run statistical analysis across different students comparing performance on various test events for future test design.
4. To correlate data received from accident reports with test data on file, e.g. the driver, the driver's driving instructor, tester and the error types made in the test.
5. To evaluate using historical track records a driving tester and/or driving instructor. In another embodiment, the test vehicle is also outfitted with one or more “black box” event data recorders (EDR) connected to the vehicle's computer (for example through the vehicle's CAN/OBD port) which continually captures and records data from the vehicle's computer. Data captured and recorded may include driving speed, acceleration, fuel consumption/fuel efficiency, braking speed and other data. The recorded data may be supplied either to the mobile computing device through a wired or wireless communications link, or may be uploaded directly to the test server. The black box data may be used to confirm one or more grades assigned by the tester to the student. For example, if the test event was approaching a traffic light controlled intersection and the tester noted that the student stopped suddenly when the light turned amber, the black box data can be used to confirm the tester's observation. In addition, black box data can be used to assign a “green” score to a student who does/does not display eco-friendly driving, for example by accelerating too hard. Suitable black box recorders for use with the present invention are readily available on the market from a number of different companies.

In yet another embodiment, the test vehicle may be outfitted with one or more external and internal video cameras which feed video images to the mobile computing device via a wired/wireless link or transmit video images directly to the test server via a wireless data link. External video cameras may be used to capture surrounding events, such as the distance and positions of other vehicles relative to the test vehicle, or the movement of pedestrians across the roadway. These video images may be used to confirm a tester's observations as to the student's operation of the vehicle in relation to outside events, e.g. a pedestrian stepping onto the roadway, tailgating, etc. Video feeds from internal cameras may be used to capture the student's behavior inside the vehicle while operating the vehicle, e.g. checks mirrors, keeps two hands on the steering wheel, etc.

It will also be appreciated that black box data and/or video data may be synchronized with the positional data being supplied by the GPS unit in order so that it can readily be determined where the vehicle was along the route when any particular black box data or video image was captured. In a further aspect of the invention, data captured and recorded using any one of the methods described above may be used by the test authority for statistical analysis, for example the test authority may want to analyze:
1. Which locations along test routes are particularly difficult for new drivers? Is there a correlation between difficult maneuvers on the driving test and accidents involving new drivers?
2. Which driving instructors are most efficient in preparing students for the driving test? Are there driving instructors that consistently prepare a student better for some types of maneuvers than for others?
3. Which driving test events in which a student fails on the first try is the student most likely to pass on a subsequent test?
4. Which driving testers display a bias towards grading certain types of test events overly positive or overly negative?
5. How do new drivers approach certain intersections which are known to be particularly dangerous? What can we learn about their behaviors that we can use to improve the standards for student driving instruction? Assuming the behavior of new drivers will not change, what can be done to make the roadway safer?

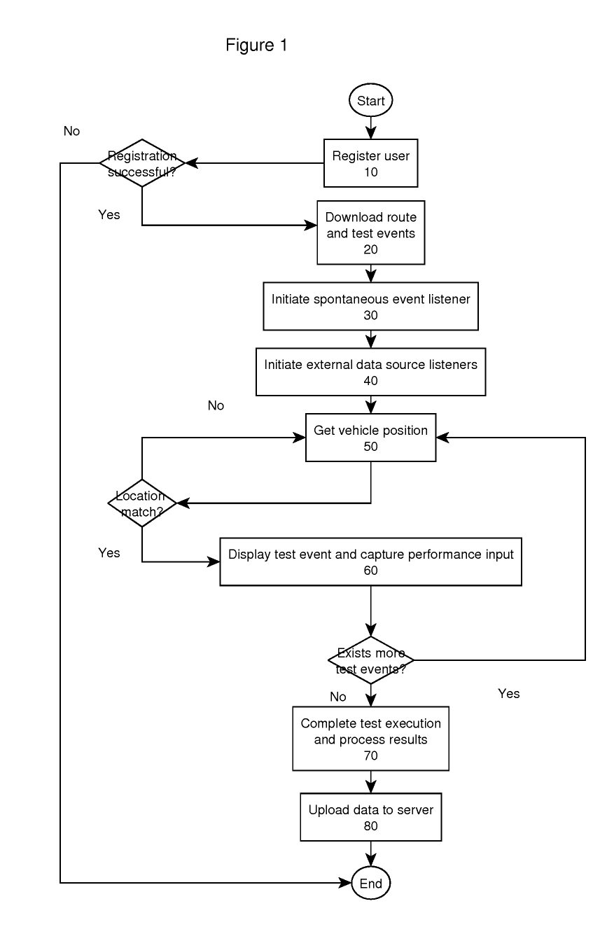

Referring now to the drawings, FIG. 1 illustrates a flow diagram of an exemplary embodiment of a method of administering a driving test according to the present invention. FIG. 1 illustrates exemplary steps performed on the client device. Preferably, the method is performed by software executed on a mobile client device that has a wireless communication link to a host computer operated by the test administration. First, client device registers 10 the student test taker. Preferably registration is performed by the mobile client device capturing input that uniquely identifies the test taker and transmitting the captured input to the host computer via a wireless communication link for authentication. Preferably the identifying input is biometric identification data, such as a fingerprint scan, retinal scan, or facial recognition, although other identifying input is contemplated as well such as passwords, PIN codes, passcards, etc. Preferably the authentication takes place at the host computer though in an alternative embodiment authentication may take place at the client device. Once the test subject's data is authenticated successfully and any other required personal details are entered the registration stage is completed. Preferably, if the name of the student's driving instructor is not already on file with the licensing agency, the instructor's name is entered into the system during the registration stage.

Next, the client device downloads 20 a route and one or more fixed test events which are associated with the route, including location coordinates for the fixed test events, from the host computer. Preferably the route is selected or created by the host computer using one of the methods described above.

Next, the client device initiates 30 a spontaneous event listener, which is a software module that runs in the background waiting to capture and record input from the tester representing a spontaneous test event which the tester wishes to add to the test while the test subject is driving. For example, the test subject may have unexpectedly failed to obey a traffic signal, and the tester is desirous of recording this event in the system. It is important that a spontaneous test event and corresponding grade and/or notes should be entered during a driving test with minimal interruption of the tester's attention. For example the tester may input a placeholder using a single key such as an ‘x’ to mark the location where a spontaneous test will be entered, and enter details of the spontaneous test event after the test is complete. In another embodiment the tester may tick off an item from a checklist of spontaneous test events and fill in the observations after the test is complete. For example in the scenario described above, the tester may tick off “Traffic violation” or driving error from a list of possibilities presented on the display of the mobile device. Later, the tester may input more details as to the nature of the traffic violation observed. Preferably the client device, which should include or be connected to a geolocating device, automatically records the location and/or time corresponding to where/when a spontaneous event is entered by the tester. Next, external data source listeners are initiated 40. External data source listeners are software modules that receive and save data from sources external to the mobile device such as data feeds from one or more connected video cameras, black box data recorders connected to the vehicle's computer, or external GPS data. Data gathered from external sources such as that described above may be recorded in order to confirm or cast doubt on the tester's input which may be error-prone, subjective or may contain an element of bias or discrimination, or to provide an alternative reliable and objective data set which the system can use to calculate a score or pass/fail result for the applicant. Preferably, data from external sources are continuously recorded by the client device together with positional data indicating the vehicle's location (and/or time of day) at the time the data was collected.

Once all listeners are activated the driving test can begin. As the student begins to drive, positional data corresponding to the current position of the test vehicle, such as location coordinates, are received 50 at the client device from a geolocation device, most preferably a GPS receiver, but other geolocation devices and methods are also contemplated within the present invention (e.g. inertial navigation, mobile phone triangulation, etc.). Each received set of location coordinates corresponding to the vehicle's position is compared against the sets of location coordinates corresponding to test events which were downloaded from the host computer. If the coordinates match, the client device displays 60 a description of the test event and prompts the tester to enter input corresponding to the student's performance on the test event. When there are no more pending test events to display, test execution is completed 70 and the captured data is processed. Finally, all raw data collected at the client device including external data is uploaded 80 to the test server, preferably via a wireless link.

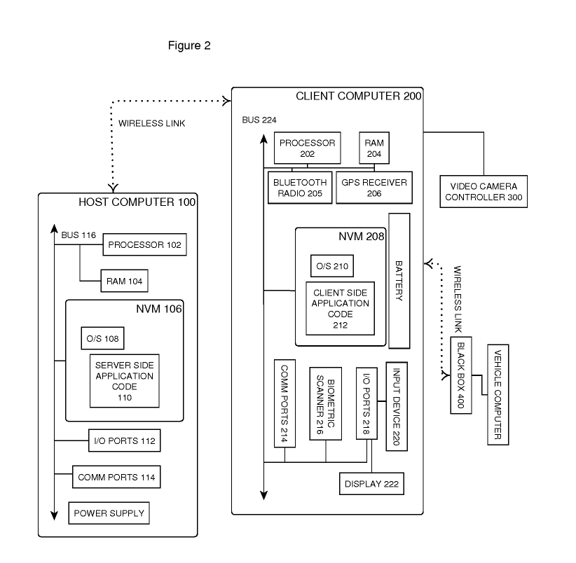

FIG. 2 is a high-level partial block diagram of an exemplary computer system 30 configured to implement the present invention. Only components of system 30 that are germane to the present invention are shown in FIG. 2. Computer system 30 includes a host computer 100 and a client computer 200 configured to communicate with one another via a first wireless communication link. Preferably, host computer 100 is a server or cluster of servers, and client computer 200 is a mobile device such as a tablet. Preferably the first wireless communication link is established via a cellular network that supports wireless data transfer such as 3G, LTE, etc. Host computer 100 includes one or more processors 102, a random access memory (RAM) 104, a non-volatile memory (NVM) 106, communication ports 114, and input/output (I/O) port 112 all communicating with each other via a common bus 116.

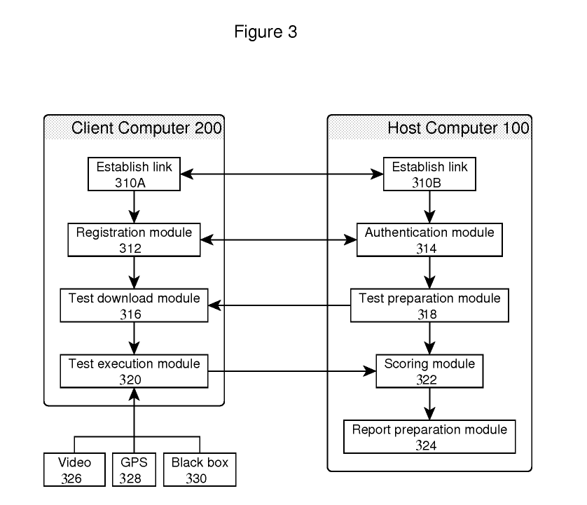

In NVM 106 are stored operating system (O/S) code 108 and server side application code 110. Server side application code 110 includes computer readable executable code for implementing the host computer functions of the present invention such as those shown and described above and in FIG. 3. Under the control of O/S 108, processor 102 loads server side application code 110 from NVM 106 into RAM 104 and executes server side application code 110 in RAM 104, causing host computer 100 to perform host computer functions for administering a driving test such as those described herein.

Client computer 200 includes one or more processors 202, a random access memory (RAM) 204, a non-volatile memory (NVM) 208, an internal or external GPS receiver 206, communication ports 214, input/output (I/O) ports 218 all communicating with each other via a common bus 224. Client computer 200 includes a display 222 and input device 220 operatively connected to processor 202 and NVM 208 via I/O ports 218. Preferably display 222 and input device 220 are integrated in a touch screen display performing both input and output functions. Preferably, client computer 200 includes a Bluetooth™ radio 205. In NVM 208 are stored operating system (O/S) code 210 and client side application code 212.

Preferably, client computer 200 is operatively connected via a wired or wireless communications link to at least one video camera controller 300 and a black box data recorder (“black box”) 400 which is operatively connected to a vehicle computer. In the configuration shown, client computer 200 is connected to video camera controller 300 through a wired link, and to black box 400 through a wireless link. A wired communications links may be established video camera controller using communications ports 214 and standard protocols for wired communications between compatible hardware devices. A wireless link between client computer 200 and a compatible black box may be established using standard wireless protocols such as Bluetooth™ using client computer's 200 Bluetooth™ radio 205 and a compatible black box 400.

Client side application code 212 includes computer readable executable code for implementing the client computer functions of the present invention such as those shown and described above and in FIG. 3. Under the control of O/S 210, processor 202 loads client side application code 212 from NVM 208 into RAM 204 and executes client side application code 212 in RAM 204 causing client computer 200 to perform client computer functions for administering a driving test such as those described herein. System 30 administers a driving test according to the present invention upon the simultaneous execution of server side application code 110 on host computer 100 and client side application code 212 on client computer 200.

FIG. 3 is a high level partial block diagram of an exemplary software embodiment for performing the method of the present invention. In this embodiment, tasks are delegated between client computer 200 and host computer 100 such that client computer 200 is tasked primarily with registering a student, downloading a test route and associated test event data, and test execution. Host computer 100 is tasked primarily with authenticating a test subject, preparing and providing the test route and associated test event data to the client computer, scoring, and report production.

In this configuration, client side software (such as 212 in FIG. 2) running on client computer 200 establishes a link with host computer 100 running server side software (such as 110 in FIG. 2) through corresponding link establishment modules 310A and 310B. In the embodiment shown in FIG. 3, client computer 200 includes a registration module 312 which communicates with an authentication module 314 on the host computer. Registration module 312 passes the test subject's personal data including identification data, preferably encrypted, to authentication module 314 for authenticating the identity of the test subject. Following successful authentication, execution on host computer 100 is passed to a test preparation module 318 which selects a test and prepares the test and associated test data for download. Execution on client computer 200 is passed to a test download module 316 which downloads the selected test and associated test data from host computer 100. Execution is then passed to a test execution module 320 on client computer 100 to administer the driving test including displaying a route, displaying test events, capturing test event input and recording data received from GPS 328, video cameras 326, and black box recorder 330. When the test is completed, recorded data is uploaded to a scoring module 322 on host computer 100 for score calculation. Next, execution is passed to a report preparation module 324 for displaying a user friendly report of the test results. In alternative embodiments, either or both of scoring module 322 and report preparation module 324 may be executed on client computer 200.

While the invention has been described with respect to a limited number of embodiments, it will be appreciated that many variations, modifications and other applications of the invention may be made. Therefore, the invention as recited in the claims that follow is not limited to the embodiments described herein.

1. A method for administering a driving test to a test subject comprising the steps of:
providing a mobile computing device and a test vehicle;
receiving from a server a driving test to said mobile computing device, said driving test including at least one test route and at least one test event, said test event including a set of location coordinates corresponding to location of said at least one test event;
continuously receiving sets of location coordinates corresponding to the current location of said test vehicle in which the mobile computing device is traveling;
wherein said method further comprising the steps of generating a description of said test event when said location coordinates of said test vehicle matches said set of location coordinates of said test event and capturing user input indicative of said test subject's performance in respect of said test event.

2. The method of claim 1, wherein said server creates said driving test based on predefined test constructs.

3. The method of claim 1, wherein said server selects said driving test from a plurality of predefined tests based on predefined test constructs.

4. The method of claim 1, wherein said server randomly selects said driving test from a plurality of predefined tests.

5. The method of claim 1, further comprising the step of authenticating said test subject's credentials with said server prior to receiving said driving test.

6. The method of claim 5, wherein said credentials are biometric credentials.

7. The method of claim 1, further comprising the steps of: receiving one or more video camera feeds from one or more video cameras fixed to said test vehicle to said mobile computing device,
capturing video camera images from said one or more feeds, and
recording said test vehicle's position at the time of each said capture via said mobile computing device.

8. The method of claim 1, further comprising the steps of:
receiving one or more vehicular event data from one or more black box event data recorders fixed to said test vehicle to said mobile computing device,
capturing vehicular data from said one or more feeds, and
recording said test vehicle's position at the time of each said capture via said mobile computing device.

9. A non-transitory computer-readable storage medium comprising a computer readable code embodied thereon, said computer readable code comprising a set of instructions that when executed on a mobile computing device causes said mobile computing device to:
receive from a server a driving test route, at least one test event associated with a location along said route, and a set of location coordinates corresponding to said test event;
receive from a geolocating device a set of location coordinates corresponding to the current location for said mobile device;
wherein said mobile computing device is instructed to generate a description of said test event when said set of location coordinates received from said geolocating device matches said set of location coordinates corresponding to said test event received from said server and to capture user input representing a test subject's performance in respect of said test event.

10. The medium of claim 9, wherein said code further comprises instructions that causes the mobile device to authenticate a test subject's credentials with said server prior to receiving said route and said at least one test event.

11. The medium of claim 10, wherein said credentials are biometric credentials.

12. The medium of claim 9, wherein said code further comprises instructions causing said mobile computing device to:
receive one or more video camera feeds from one or more video cameras fixed to the test vehicle;
capture video camera images from said one or more feeds; and
record said test vehicle's position at the time of each said capture.

13. The medium of claim 9, wherein said code further comprises instructions that cause said mobile computing device to:
receive one or more vehicular event data from one or more black box event data recorders fixed to the test vehicle; capture vehicular data from said one or more data recorders; and
record said test vehicle's position at the time of each said capture.

14. A system for administering a driving test comprising:
a server;
a client device in operative communication with said server; and
a geolocating device operatively connected to said client device;
said client device is operative to receive from said server a driving route, at least one test event corresponding to a respective fixed location along said driving route, and fixed location coordinates of each said at least one test event; and
said client device is operative to receive from said geolocating device current location coordinates corresponding to said client device's current location;
wherein said client device generates a description of said test event when said client device's current location matches a fixed location for said test event and captures user input indicative of a test subject's performance on said test event.

15. The system of claim 14, wherein said server comprising:
a processor, and
a non-transitory computer-readable storage medium operationally coupled to said processor;
said non-transitory computer-readable storage medium stores executable code readable by said processor.

16. The system of claim 14, wherein said code comprising instructions that when executed on said client device causes said client device to administer a driving test by:
determining, based on a set of pre-defined criteria, a driving test route and at least one test event along said route, said at least one test event is associated with a set of location coordinates;
sending to a mobile computing device said driving test route and said at least one test event; and
receiving from said mobile computing device a respective performance grade for at least one said test event.

17. The system of claim 16, wherein said instructions further comprising calculating a score for said driving test based in part on each said received performance grade.
